(19) United States
(12) Patent Application Publication
(10) Pub. No.: US 2007/0246683 A1
(43) Pub. Date: Oct. 25, 2007

(54) Reduced dusting gypsum composites and method of making them

(76) Inventors: David Paul Miller, Lindenhurst, IL (US); Richard B. Spencer, Villa Park, IL (US)

Correspondence Address: GREER, BURNS & CRAIN, LTD., 300 SOUTH WACKER DRIVE, SUITE 2500, CHICAGO, IL, 60603, US

(21) Appl. No.: 11/409,702

(22) Filed: Apr. 24, 2006

(51) Int. Cl. C09K 3/22

(52) U.S. Cl. 252/88.1

(57) ABSTRACT

A composite product is made from a slurry that includes host particles having alpha-calcined calcium sulfate hemihydrate crystals formed in the voids, cracks, fissures or other surface opening of the host particle, alpha-calcined calcium sulfate hemihydrate crystals and a dust reducing agent. The dust reducing agent is at least one of a synthetic wax and soy lecithin. As the slurry cools, the hemihydrate forms an interlocking matrix of calcium sulfate dihydrate crystals, some of which are attached to host particles.

A process for making the slurry includes forming a slurry of host particles and calcium sulfate dihydrate, then heating the slurry to at least 140° C. and autogenous pressure until substantially all of the calcium sulfate dihydrate has been converted to alpha-calcined calcium sulfate hemihydrate. The dust reducing agent is added to the slurry. A composite panel is made by further dewatering the slurry and forming a panel.

### BACKGROUND OF THE INVENTION

This invention relates to a composition for a composite material made of gypsum and fibers. More specifically, it relates to a composition for a composite material panel that generates less airborne dust when the panel is cut.

A strong composite product is made by mixing calcium sulfate dihydrate with wood or fiber particles prior to calcination of the gypsum. After a dilute slurry is formed of gypsum and particles, it is heated under pressure to at least 140° C. to convert the calcium sulfate dihydrate into the alpha form of calcium sulfate hemihydrate, also known as stucco. The alpha form used in this process is characterized by the formation of elongated, acicular crystals. As the crystals form, some of them will form within pores, cavities and other imperfections in the particle surface. When the slurry cools, the stucco rehydrates, forming an interlocking matrix of gypsum crystals and reinforcing particles. Excess water is removed by filtration and pressing of the composite, forming a composite filter cake of the desired thickness.

Gypsum composites, particularly panel products, generate dust when cut with conventional woodworking tools such as saws and planers. Much of the dust is very fine, taking a long time to settle. When air currents are present, the fine dust is disseminated or diffused long distances in the time it is airborne. Such dust is bothersome and a nuisance to both installers and users, and is considered a disadvantage that limits the use of composite panels in areas where it is, otherwise, well suited.

Materials could be added to the composite to reduce dusting, however, they should not interfere with other properties of the product or process of its manufacture. Many potential additives retard the set of the calcined gypsum, increasing the time needed for the product to harden and thereby reducing the production rate. Potential additives should not cause the composite to stick to the pressing fabrics or belts. It should not increase foaming during the forming process, which reduces both product quality and production rate. Dust-reducing additives should not negatively impact these and other properties of the composite panel.

Liquid paraffin and oils are known to reduce dust in plaster-based compositions, such as those disclosed in PCT Publication WO/00/34200. However, these additives have a number of drawbacks. When such liquids are included in the applied composition, they tend to migrate toward the surface of the workpiece, giving an uneven distribution of dust reducing properties within the applied composition. The migration may cause the plaster to dry unevenly as well. Oil and liquid waxes also can cause loss of adhesion to the substrate at higher concentrations.

U.S. Pat. Nos. 6,355,099 and 6,673,144 utilize polyethylene glycols in machinable plaster and joint compounds, respectively. In both of these applications, the calcium sulfate hemihydrate was calcined in a separate step with no fibers present. The polyethylene glycol was then added to the dry, powdered calcium sulfate hemihydrate slurry at room temperature. Alpha, beta or mixtures of alpha and beta-calcined gypsum are suitable for use in this invention. No excess water is used, and the hydration process absorbs all of the water.

There is, therefore, a need in the art for an improved composite material that minimizes or localizes generation of airborne dust.

### SUMMARY OF THE INVENTION

These and other problems are solved by the present invention which features a composite product that generates less airborne dust when sanded, planed or cut. More specifically, fine dust generated while cutting is agglomerated into large particles that settle quickly. The present invention is a composite material that includes an interlocked matrix of gypsum dihydrate crystals, host particles and at least one dust reducing agent such as polyethylene glycol or soy lecithin.

This composite is made from a slurry that includes host particles having alpha-calcined calcium sulfate hemihydrate crystals formed in the voids, cracks, fissures or other surface opening of the host particle, alpha-calcined calcium sulfate hemihydrate crystals and a dust reducing agent. The dust reducing agent is at least one of polyethylene glycol and soy lecithin. As the slurry cools, the hemihydrate forms an interlocking matrix of calcium sulfate dihydrate crystals, some of which are attached to host particles.

A process for making the slurry includes forming a slurry of host particles and calcium sulfate dihydrate, then heating the slurry to at least 140° C. and autogenous pressure until substantially all of the calcium sulfate dihydrate has been converted to alpha-calcined calcium sulfate hemihydrate. After the slurry exits the reactors to atmospheric pressure and 100° C., the dust reducing agent is added to the slurry. A composite panel is made by further forming a panel and dewatering the slurry.

One or more of the problems described above are solved by the addition of one of the dust reducing agents to composite materials. At least some of the embodiments of this invention are acidic in nature. As such, they are less likely to retard setting of the calcined gypsum and reduce the production rate compared to alkaline dust reducing agents.

Some embodiments of this invention have antifoaming properties that would tend to decrease, not increase, the amount of foam generated during the manufacturing process. Product quality is improved compared to processes where foam is allowed to interfere with the dewatering process.

Polyethylene glycol is known as a mold release agent. For that reason, it is believed that it will have non-stick properties necessary to allow the composite to easily be removed from belts and pressing fabrics used in the dewatering process. This dust reducing agent may also improve the surface smoothness of composite materials as well as decrease surface sticking to process equipment with the resulting surface damage during pressing.

### DETAILED DESCRIPTION OF THE INVENTION

Particle reinforced composite gypsum articles of the present invention are made by forming a pumpable, flowable gypsum slurry. The primary component of the slurry is a gypsum-containing material. The starting gypsum-containing material includes calcium sulfate dihydrate in any of its forms, including landplaster, terra alba, any synthetic gypsum or mixtures thereof. One preferred gypsum is KCP gypsum, a synthetic gypsum made as a byproduct of power plant flue gas cleaning by Allegheny Energy Supply (Willow Island, W.V.). Other suitable gypsum products, including landplaster and terra alba, are available from United States Gypsum Company, Southard, OK. As well as only synthetic or only natural gypsum, mixtures of synthetic KCP gypsum and natural gypsum are used advantageously, particularly in a ratio of about 1-5:1 by weight. Wet gypsum can be used in the slurry without first drying it, unlike conventional paper-faced drywall. Preferably, the gypsum is of a relatively high purity, and is finely ground. The particle distribution of the gypsum preferably includes at least 92% of the particles at minus 100 mesh or smaller. The gypsum can be introduced as a dry powder or as an aqueous slurry.

Another component of the gypsum slurry is a host particle. A “host particle” is intended to refer to any macroscopic particle, such as a fiber, a chip or a flake, of any substance that is capable of reinforcing gypsum. The particle, which is generally insoluble in the slurry liquid, should also have accessible voids therein; whether pits, cracks, crevices, fissures, hollow cores or other surface imperfections, which are penetrable by the slurry and within which calcium sulfate crystals are formable. It is also desirable that such voids are present over an appreciable portion of the particle. The physical bonding between the host particle and the gypsum will be enhanced where the voids are plentiful and well distributed over the particle surface. Preferably, the host particle has a higher tensile and flexural strength than the gypsum. A lignocellulosic fiber, particularly a wood or paper fiber, is an example of a host particle well suited for the slurry and process of this invention. About 0.5 to about 30% by weight of the host particles are used, based on the weight of the gypsum-containing component. More preferably, the-finished product includes about 3% to about 20% by weight, more preferably from about 5% to about 15% host particles. Although the discussion that follows is directed to a wood fiber, it is not intended to be limiting, but representative of the broader class of suitable compounds useful here.

Preferably, the wood fiber is in the form of recycled paper, wood pulp, cardboard, wood flakes, other lignocellulosic fiber source or mixtures thereof. Recycled cardboard containers are a particularly preferred source of host particles. The-particles may require prior processing to break up clumps, separate oversized and undersized material, and in some cases, pre-extract contaminates that could adversely affect the calcination of the gypsum, such as hemicellulose, flavonoids and the like.

At least one dust reducing agent selected from a synthetic wax and soy lecithin is present in the composite product. The exact molecular weight of the dust reducing agent is chosen primarily on the basis of melting point. The dust reducing agent should be in a solid form in the cooled and dried product. When the melting point of the dust reducing agent is sufficiently low that the polymer melts due to friction when it is being cut, the liquefied dust reducing agent agglomerates fines of gypsum and host particles. When particles of dust reducing agent, gypsum and host particles become heavy enough to fall away from the cutting site, the particle starts to cool, solidification of the dust reducing agent holds the gypsum fines and host particles firmly in the particle, preventing them from becoming airborne.

Preferred dust reducing agents include a synthetic wax such as polyethylene glycol (“PEG”). Particularly preferred waxes have an average melting point greater than 70° F. (21° C.) and less than about 140° F. (60° C.). Within this range, the dust reducing agent is most likely to be solid at room temperature, melt from friction generated by cutting, then resolidify as fines fall away from the cutting area. Polyethylene glycols from Clariant (Clariant North America, Mount Holly, N.C.) in either a flake or powder form are particularly preferred, including Polyglykol 6000S, Polyglykol 8000S and Polyglykol 8000P.

Although the suitability of a particular wax is defined by its melting behavior while cutting, the preferred dust reducing agents are also discussed here in terms of molecular weight since the products are generally sold by molecular weight. Polyethylene glycols with molecular weights greater than 1450 Daltons are generally suitable. Preferably, the average molecular weight of PEG ranges from about 3350 Daltons to about 20,000 Daltons and most preferably from about 8000 Daltons to about 20,000 Daltons. A preferred PEG is PEG 6000PF. The preferred molecular weight range for branched molecules would be lower, such as MPEG in the range of about 750 to about 5000 Daltons. More preferably, MPEG with an average molecular weight range of from about 750 to about 2000 Daltons is used. MPEG having an average molecular weight of from about 1000 to about 1200 Daltons is most preferred. Molecular weight, branching and side chain composition all contribute to how the dust reducing agent.

Another preferred dust reducing agent is lecithin, a soy protein. Lecithin is effective as a dust reducing agent either as a dry, oil-free powder or in a liquid form with soy oil. Preferred lecithins include hydroxyated hydrophilic lecithins such as the CENTROLENE Series (The SOLAE Company, St. Louis, Mo.). CENTROLENE F Powdered Soybean Lecithin and CENTROLENE A Soybean Lecithin Liquid are especially preferred.

After mixing the slurry of host particles and gypsum, it is heated under pressure to calcine the gypsum, converting it to calcium sulfate alpha hemihydrate. While not wishing to be bound by theory, it is believed that the dilute slurry wets out the host particle, carrying dissolved calcium sulfate into the voids and crevices therein. The hemihydrate eventually nucleates and forms crystals in situ in and on the voids of the host particle. The crystals formed are predominantly acicular crystals that fit into smaller crevices in the host particle and anchor tightly as they form. As a result, calcium sulfate alpha hemihydrate is physically anchored in the voids of the host particles. Crystal modifiers, such as alum, are optionally added to the slurry (General Alum & Chemical Corporation, Holland, Ohio). A process for making gypsum fiberboard with alum is described in U.S. Patent Publication No. 2005/0161853, published Jul. 28, 2005, herein incorporated by reference.

Elevated temperatures and pressures are maintained for a sufficient time to convert a large fraction of the calcium sulfate dihydrate to calcium sulfate hemihydrate. Under the conditions listed above, approximately 15 minutes is sufficient time to solubilize the dihydrate form and recrystallize the alpha hemihydrate form. While under pressure in the autoclave, it is believed that the dissolved calcium sulfate alpha hemihydrate crystals form within and penetrate the crevices and spaces of the host particles, using the host particle as nucleation sites from which to anchor and grow long, acicular crystals. Pressures of up to 50-55 psig (3.5-3.9 kg/cm²) or higher are common. When calcining is complete, the pressure on the autoclave is relieved to atmospheric pressure, and optional additives are added to the slurry. After formation of the fiber-rich hemihydrate, the slurry is optionally flash dried as the alpha-hemihydrate for later use.

In a preferred embodiment, the additives include a silicone dispersion and a catalyst that polymerizes the silicone compound to form a silicone polymer as disclosed in U.S. Ser. No. 11/215,048, herein incorporated by reference. Water and the silicone compound are preferably combined in a high intensity mixing device that creates a fine dispersion of the silicone oil in water. The dispersion is preferably injected into the gypsum slurry between autoclaving calciners and static mixer upstream of a forming process. The silicone compound selected must be adapted to cure or polymerize into a silicone polymer in the presence of magnesium oxide during the drying step to provide improved water resistance to the finished product. A preferred silicone compound is a hydrogensiloxane such as SILRES BS 94 by Wacker Chemical Corporation (Adrian, Mich.).

Preferably, the silicone component is present in amounts ranging from about 0.08% to about 1% based on the weight of the gypsum containing material. More preferably, the silicone component is present in amounts of about 0.2 to about 0.8% by weight or from about 0.4% to about 0.5%. The silicone compound selected is preferably chemically stable with respect to the gypsum and the wood fibers which make up the gypsum product. The silicone component preferably does not interfere with any additives to modify the physical properties or set time of the gypsum, and is adapted to cure at the core temperature achieved by the article during final drying of the product.

Water resistance is imparted to the gypsum article by the presence of a silicone polymer that is dispersed throughout the gypsum matrix. This is achieved by the addition of the siloxane and catalyst solution which disperses throughout the slurry. Magnesium oxide, also known as “magnesia”, is required to catalyze the silicone compound. Formation of the silicone polymer in situ assures that the polymer and resulting water resistance are distributed throughout the finished product.

Preferably, the magnesium oxide is present in amounts from about 0.08% to about 1.5% based on the weight of the gypsum component. Preferably, the magnesium oxide is present in amounts of about 0.3% to about 1.0%, and more preferably from about 0.5% to about 1.0%. Use of dead burned magnesium oxide is most preferred.

A catalyst slurry is made by mixing the magnesium oxide in water. A sufficient amount of water is used to form a dilute, pumpable slurry. Many different water sources are useful, including fresh water, water recycled from this process or water recycled from other processes, such as gypsum board manufacturing processes. The magnesium oxide is metered into a mixing tank using a weight loss or volumetric feeder method well known to those skilled in the art. Water is continuously fed to the tank and high intensity mixing is used to disperse the powder into the liquid phase. The resulting catalyst slurry is then injected into the gypsum slurry using a positive displacement pump, preferably a progressing cavity pump.

The slurry temperature is used to control the onset of rehydration. At temperatures below 160° F. (71° C.), the interlocking matrix of dihydrate crystals reforms, where some of the dihydrate crystals are anchored in the voids of the host particles. This results in a very strong dihydrate crystal matrix into which the host particles have been incorporated. After formation of the dihydrate matrix, the silicone polymer matrix is also formed from the siloxane molecules. Since both of the matrices are formed from repeating units that are scattered throughout the slurry, an intertwined system of both the dihydrate crystal matrix and the silicone polymer matrix is formed, with the silicone matrix forming around the gypsum matrix. The magnesium oxide is distributed throughout the product composite surrounded by the silicone polymer matrix.

Additional additives are optionally included in the product slurry as desired to modify properties of the finished product as desired. Accelerators (up to about 35 lb./MSF (170 g/m2)) are added to modify the rate at which the hydration reactions take place. A preferred set accelerator, HRA (United States Gypsum Company, Gypsum, Ohio), is calcium sulfate dihydrate freshly-ground with sugar at a ratio of about 5 to 25 pounds (2.3 to 11.4 kg) of sugar per 100 pounds (45 kg) of calcium sulfate dihydrate. It is further described in U.S. Pat. No. 2,078,199, herein incorporated by reference. Alum is also optionally added to fiberboard for set acceleration. Alum has the added advantage of aiding in the flocculation of small particles during dewatering of the slurry by modifying the crystal configuration. Additional water-resistance materials, such as wax, are optionally added to the slurry. The additives, which also include preservatives, fire retarders, and strength enhancing components, are added to the slurry when it comes from the autoclave.

It is desirable to continuously agitate the slurry with gentle stirring or mixing to keep all the particles in suspension. After the hemihydrate has formed and precipitated out of solution as long, acicular hemihydrate crystals, the pressure on the product slurry is released as the slurry is discharged from the autoclave. The siloxane emulsion and other desired additives are typically added at this time.

In a preferred embodiment, fiberboard is made from the composite slurry. The gypsum-containing component is gypsum and the host particle is paper fiber. Paper slurry is hydrapulped to a 4% suspension and the gypsum is dispersed in water at about 40% solids to form a slurry. These two liquid streams are combined to form a dilute gypsum slurry having about 70% to about 95% by weight water. The gypsum slurry is processed in a pressure vessel at a temperature sufficient to convert the gypsum to calcium sulfate alpha hemihydrate. Steam is injected into the vessel to bring the temperature of the vessel up to between 290° F. (143° C.) and about 315° F. (157° C.), and autogenous pressure. The lower temperature is approximately the practical minimum at which the calcium sulfate dihydrate will calcine to the hemihydrate form within a reasonable time. The higher temperature is about the maximum temperature for calcining without undue risk of fiber decomposition. The autoclave temperature is preferably on the order of about 295° F. (146° C.) to about 305° F. (152° C.).

Following calcining, the additives are injected into the gypsum slurry stream. Some additives may be combined prior to addition to the gypsum slurry. Preferably, the silicone dispersion and the catalyst slurry are separately injected into the gypsum slurry prior to dispensing of the slurry at a headbox. Preferably the additives are dispersed using a large static mixer, similar to that disclosed in U.S. Patent Publication No. 2002/0117559, herein incorporated by reference. Passage of the slurry and additives over the irregular interior surfaces of the static mixer causes sufficient turbulence to distribute the additives throughout the slurry.

While still hot, the slurry is pumped into a fourdrinier-style headbox that distributes the slurry along the width of the forming area. Preferably, the dust reducing agent is added to the slurry at or immediately prior to the headbox. From the headbox, the slurry is deposited onto a continuous drainage fabric where the bulk of the water is removed and on which a filter cake is formed. As much as 90% of the uncombined water may be removed from the filter cake by the wet felting conveyor. Dewatering is preferably aided by a vacuum to remove additional water. As much water is preferably removed as practical before the hemihydrate cools and is converted to the dihydrate. The formation of the filter cake and its dewatering are described in U.S. Pat. No. 5,320,677, herein incorporated by reference.

The slurry, including a plurality of such host particles, is compacted and formed into any desired shape. Any forming method can be used, including pressing, casting, molding and the like. As a consequence of the water removal, the filter cake is cooled to a temperature at which rehydration may begin. However, it may still be necessary to provide additional external cooling to bring the temperature low enough to effect the rehydration within an acceptable time.

While the filter cake is still shapeable, it is preferably wet-pressed into a board or panel of the desired size, density and thickness. If the board is to be given a special surface texture or a laminated surface finish, the surface is preferably modified during or following this step. A method for manufacturing textured panels and a description of panels made therefrom are described in more detail in U.S. Pat. No. 6,197,235, herein incorporated by reference. During the wet-pressing, which preferably takes place with gradually increasing pressure and increasing water removal to preserve the product integrity, two things happen. Additional water is removed, further cooling the filter cake to a temperature where rehydration occurs. The calcium sulfate hemihydrate crystals are converted to dihydrate crystals in situ in and around the wood fibers.

After rehydration is sufficient that the filter cake holds its shape, it is cut, sent to a kiln for drying and trimmed into boards. During the drying step, it is important to raise the temperature of the product high enough to promote evaporation of excess moisture, but low enough that calcination does not occur. It is desirable to dry the product under conditions that allows the product core temperature to reach between about 165° F. (74° C.) and about 190° F. (88° C.) and more preferably 165° F. (74° C.).

In the examples that follow, proportions (parts) are all on a weight basis. The gypsum used was 75% synthetic KCP gypsum and 25% natural gypsum from United Stated Gypsum, Southard, OK.

### EXAMPLE 1

About 136 pounds (61.7 kg) recycled paper fiber and 773 pounds (350.6 kg) gypsum were slurried in 5151 pounds (2336 kg) of water to generate a 6060 pound (2749 kg) slurry containing 15% solids. The slurry was calcined at 295° F. (146° C.) and 53 psig (3.7 kg/cm²) in a steam saturated environment for 15 minutes to generate a uniform mixture of paper fiber and alpha hemihydrate calcium sulfate. Ten pounds of ground gypsum, 1 pound papermakers alum (0.45 kg) and 2 pounds (0.9 kg) CENTROLENE A Lecithin were added to the slurry mixture and the material was dewatered and pressed into a panel product. The product was allowed to fully set and convert the alpha hemihydrate back into the dihydrate form prior to drying the residual moisture from the panels. The panels were then ready for use as a panel product for walls, ceilings, and the like.

### EXAMPLE 2

Forty pounds (18.1 kg) recycled paper fiber and 227 pounds (103.0 kg) gypsum are slurried in 1513 pounds (686.3 kg) of water to make a slurry containing 15% solids. The slurry was calcined at 295° F. (146° C.) at 53 psi (3.7 kg/cm²) in a steam saturated environment for 15 minutes to generate a uniform mixture of paper fiber and alpha hemihydrate calcium sulfate. 5.4 Pounds (2.5 kg) of ground gypsum and 0.8 pounds (0.36 kg) Wacker BS 94 methyl hydrogensiloxane (Wacker Chemical Corporation, Adrian, Mich.) and 1 pound (0.45 kg) magnesium oxide catalyst (Martin Marietta Magnesia Specialties, LLC, Raleigh, N.C.) and 1 pound Polyglykol 8000S were added to the slurry mixture. The material was then dewatered and pressed into a panel product. The product was allowed to fully set and convert the alpha hemihydrate back into the dihydrate form prior to drying the residual moisture from the panels. The panels were then ready for use as a panel product for walls, ceilings, and the like.

Samples of the products of Examples 1 and 2 and control samples having no dust reducing agent were cut using a conventional circular saw with a conventional woodworking steel blade. Samples both with and without dust reducing agents were cut at a constant feed rate into the saw and the resulting airborne dust observed. Observations made at the time indicated there was less airborne dust with the PEG and lecithin samples than with control samples made with no dust reducing agent.

While a particular embodiment of the low-dust composite material and method of making it has been shown and described, it will be appreciated by those skilled in the art that changes and modifications may be made thereto without departing from the invention in its broader aspects and as set forth in the following claims.

What is claimed is:

1. A composite article comprising:
host particles distributed throughout said article, having a plurality of calcium sulfate dihydrate crystals formed in at least one of the group consisting of voids, crevices, pits, cracks, fissures, hollow cores and other surface imperfections in said host particles;
an interlocking matrix of calcium sulfate dihydrate crystals distributed throughout said article, including one or more crystals from said plurality of calcium sulfate dihydrate crystals formed in said host particles; and
at least one dust reducing agent comprising at least one of the group consisting of a polyethylene glycol and soy lecithin distributed throughout said article and surrounded by said calcium sulfate matrix.

2. The composite article of claim 1 wherein said dust reducing agent comprises polyethylene glycol.

3. The composite article of claim 2 wherein said polyethylene glycol comprises a blend of hard and soft solid polyethylene glycols.

4. The composite article of claim 1, wherein said host particles comprise a lignocellulosic fiber.

5. The composite article of claim 4, wherein said lignocellulosic fiber comprises a wood or paper fiber.

6. The composite article of claim 5, wherein said wood or paper fiber comprises at least one of the group consisting of recycled paper, wood pulp, cardboard and wood flakes.

7. The composite article of claim 1 wherein said interlocking matrix of calcium sulfate dihydrate crystals further comprises a silicone polymer matrix intertwined throughout said calcium sulfate dihydrate matrix.

8. The composite article of claim 7 wherein said silicone polymer is polymerized from a siloxane compound.

9. A composite slurry comprising:
host particles distributed throughout said slurry, having a plurality of alpha-calcined calcium sulfate hemihydrate crystals formed in at least one of the group consisting of voids, crevices, pits, cracks, fissures, hollow cores and other surface imperfections in said host particles;
alpha calcined calcium sulfate hemihydrate crystals; and
at least one dust reducing agent comprising at least one of the group consisting of a polyethylene glycol and soy lecithin distributed throughout said slurry.

10. The slurry of claim 9 wherein said dust reducing agent comprises polyethylene glycol.

11. The slurry of claim 10 wherein said polyethylene glycol comprises a blend of hard and soft solid polyethylene glycols.

12. The slurry of claim 9, wherein said host particles comprise a lignocellulosic fiber.

13. The slurry of claim 12, wherein said lignocellulosic fiber comprises a wood or paper fiber.

14. The slurry of claim 13, wherein said wood or paper fiber comprises at least one of the group consisting of recycled paper, wood pulp, cardboard and wood flakes.

15. The slurry of claim 9 further comprising a siloxane compound and a catalyst configured for polymerizing said silicone compound.

16. The slurry of claim 15 wherein said catalyst comprises magnesia.

17. A method of making a composite material comprising:
forming a slurry of host particles and calcium sulfate dihydrate;
heating said slurry to at least 140° C. and autogenous pressure until substantially all of said calcium sulfate dihydrate has been converted to alpha-calcined calcium sulfate hemihydrate;
adding a dust reducing agent comprising at least one of the group consisting of polyethylene glycol and lecithin to the slurry; and
dewatering the slurry.

18. The method of claim 17 wherein said dewatering step further comprises distributing the slurry on a fabric and pressing it to remove excess water.

19. The method of claim 17 further comprising mixing the dust control agent into the slurry.

20. The method of claim 17 wherein said heating step comprises inserting steam into an autoclave containing the slurry.

21. The method of claim 17 further comprising introducing a siloxane compound and a catalyst configured for polymerizing the siloxane compound to the slurry prior to said dewatering step.

22. The method of claim 17 further comprising dispersing the siloxane in water prior to said introducing step.
